(19) United States
(12) Patent Application Publication
(10) Pub. No.: US 2004/0025047 A1
(43) Pub. Date: Feb. 5, 2004

(54) Wireless network

(76) Inventors: Clive Mayne, Herts (GB); Nick Moss, Middlesex (GB); Phillip Geoffrey Claridge, Bucks (GB); Jon Curnyn, Bucks (GB); Neil Evans, Herts (GB); Simon Gawne, Herts (GB); Simon Harrison, Bucks (GB); Daniel Shaw, Slought (GB); Simon Gooch, Bucks (GB); Paul Austin, York (GB); Roland Franks, Bucks (GB); Jeremy Curtis, Beds (GB)

Correspondence Address: BEYER WEAVER & THOMAS LLP, P.O. BOX 778, BERKELEY, CA, 94704-0778, US

(21) Appl. No.: 10/311,134

(22) PCT Filed: Jun. 13, 2001
(86) PCT No.: PCT/GB01/02587

(30) Foreign Application Priority Data
Jun. 13, 2000 (GB) 0014431.1

(51) Int. Cl. H04L 9/00

(52) U.S. Cl. 713/200; 455/426.2

(57) ABSTRACT

The present invention provides a system which uses a number of network nodes (2) which can communicate wire lessly with communications devices (3-8) coupled to the network. The network nodes are all connected to a network server (1) which can be used to provide additional services, such as Internet connection. The system uses at least a local short range radio connection for interconnecting the network nodes (2) to the communications device (3-8), thereby allowing the user of a communications device access to the network from anywhere within range of a suitable network node. This allows network nodes to be located throughout a building, such that a user can have access to the communications network at any location within the building.

### FIELD OF THE INVENTION

The present invention relates to a method and apparatus for providing a wireless network, and in particular, wireless Internet access.

### BACKGROUND TO THE INVENTION

Currently, the majority of computer networks utilize some form of wiring for interconnecting the computers on the network. These systems suffer from the major drawbacks that wiring has to be installed within the building to enable the network to be fitted, and additionally, should a fault with the wiring develop, this can lead to the need for wiring to be replaced. In addition to this, the wiring can cause problems due to interference with other electrical equipment within the building, as well as only having a limited bandwidth. Furthermore, different networks require different wiring standards which further leads to the complexity of installing networks in buildings.

Wireless types of networks are now becoming more wide spread. Wireless communication can be broken down into one of three main categories, radio, cellular and local. Radio communications are used for mainly long distance work, and cellular communications are used for mobile phones and the like. At present, the cellular system can also be used to provide limited Internet access using WAP (Wireless Access Protocol) phones. Full Access is also possible via a GSM modem and a PC/PDA.

In addition to this, the local communication standards are also provided for short-range radio communication. These systems have been used within the production of wireless networks. However, currently the systems require a large master base unit which is capable of sending a signal to each end station connected to the network. The base units therefore have to be of a reasonably high power and this can lead to problems of interference with other electrical equipment. In addition to this, the technology used in these devices is not widespread and accordingly, it is not possible to integrate this form of network with other devices.

The present invention provides a system which uses a number of network nodes which can communicate wirelessly with communications devices coupled to the network. The network nodes are all connected to a network server which can be used to provide additional services, such as Internet connection. The system uses at least a local short range radio connection for connecting the network nodes to the communications devices, thereby allowing the user of a communications device access to the network from anywhere within range of a suitable network node. This allows network nodes to be located throughout a building, such that a user can have access to the communications network at any location within the building.

The system advantageously uses Bluetooth technology for implementing communication between the communications devices and the network nodes, as well as being able to implement the DECT (Digital Enhanced Cordless Telecommunications), Wireless Local Loop, versions of HiperLAN, and GPRS (General Packet Radio Service) protocols for communication with external networks, such as the Internet.

GPRS is a service running over the digital cellular network to provide constant on-line access to private or public IP networks. GPRS reuses existing cellular infrastructure, such as GSM and TDMA cellular phone networks.

GPRS operates by aggregating together a number of GSM channels within the range of one cellular base station for data use (typically between two and eight channels). These channels are then used as a data highway to provide data services to mobile data users within that cell. All data is encrypted before transmission. On reception at the base station the GPRS data is then steered onto an overlay network separating data from voice traffic. Dependent on the packet addressing information and in the privileges of the GPRS user attached to the network the data may be forwarded to another GPRS terminal, the Internet or to a VPN.

A Bluetooth Radio Frequency (RF) system is a Fast Frequency Hopping Spread Spectrum (FFHSS) system in which packets are transmitted in regular time slots on frequencies defined by a pseudo random sequence. A Frequency Hopping system provides Bluetooth with resilience against interference.

Interference may come from a variety of sources including microwave ovens and other communication systems operating in this unlicensed radio band which can be used freely around the world. The system uses 1 MHz frequency hopping steps to switch among 79 frequencies in the 2.4 GHz Industrial, Scientific and Medical (ISM) band at 1600 hops per second with each channel using a different hopping sequence.

The Bluetooth baseband architecture includes a Radio Frequency transceiver (RF), a Link Controller (LC) and a Link Manager (LM) implementing the Link Manager Protocol (LMP).

Bluetooth version 1.1 supports asymmetric data rates of up to 721 K bits per second and 57.6 K bits per second and symmetric data rates of up to 432.5 K bits per second. Data transfers may be over synchronous connections, Bluetooth supports up to three pairs of symmetric synchronous voice channels of 64 K bits per second each.

Bluetooth connections operate in something called a piconet in which several nodes accessing the same channel via a common hopping sequence are connected in a point to multi-point network. The central node of a piconet is called a master that has up to seven active slaves connected to it in a star topology. The bandwidth available within a single piconet is limited by the master, which schedules time to communicate with its various slaves. In addition to the active slaves, devices can be connected to the master in a low power state known as park mode, these parked slaves cannot be active on the channel but remain synchronised to the master and addressable. Having some devices connected in park mode allows more than seven slaves be attached to a master concurrently. The parked slaves access the channel by becoming active slaves, this is regulated by the master.

Multiple piconets with overlapping coverage may co-operate to form a scatternet in which some devices participate in more that one piconet on a time division multiplex basis. These and any other piconets are not time or frequency synchronised, each piconet maintains is own independent master clock and hopping sequence.

DECT is the world's most widely implemented digital standard for cordless phones for office and residential use, and for small wireless PBX (Private Branch Exchange). DECT is also used as a wireless local loop technology with direction aerials to provide phone service to remote users for distances of up to 15 km.

Like Bluetooth, DECT has a number of protocols to define different services that have been developed over time. The most common profile is the Generic Access Profile (GAP) that provides the basis for all of the speech services familiar to home and office users of DECT cordless phones. Basic data services are provided via a ISDN Interworking Profile that allows DECT to mulate one or more 64 k bit/sec ISDN channels,

More recent profiles provide support for use as a roaming voice terminal and provides for data services up to 552 k bit/sec. These profiles include the DECT Multimedia Access Profile (DMAP) incorporating GAP (voice) and DPRS (data) for multimedia solutions, and DECT integrated in Wireless Access Protocol (WAP) specifications.

### BRIEF DESCRIPTION OF THE DRAWINGS

Examples of the present invention will now be described with reference to the accompanying drawings, in which:

FIG. 1 is a schematic representation of a network according to the present invention;

FIG. 2 is a schematic diagram of the WIS of FIG. 1;

FIG. 3 is a schematic diagram of the LAD of FIG. 1; and,

FIGS. 4 to 9 are examples of alternative network arrangements.

### DETAILED DESCRIPTION

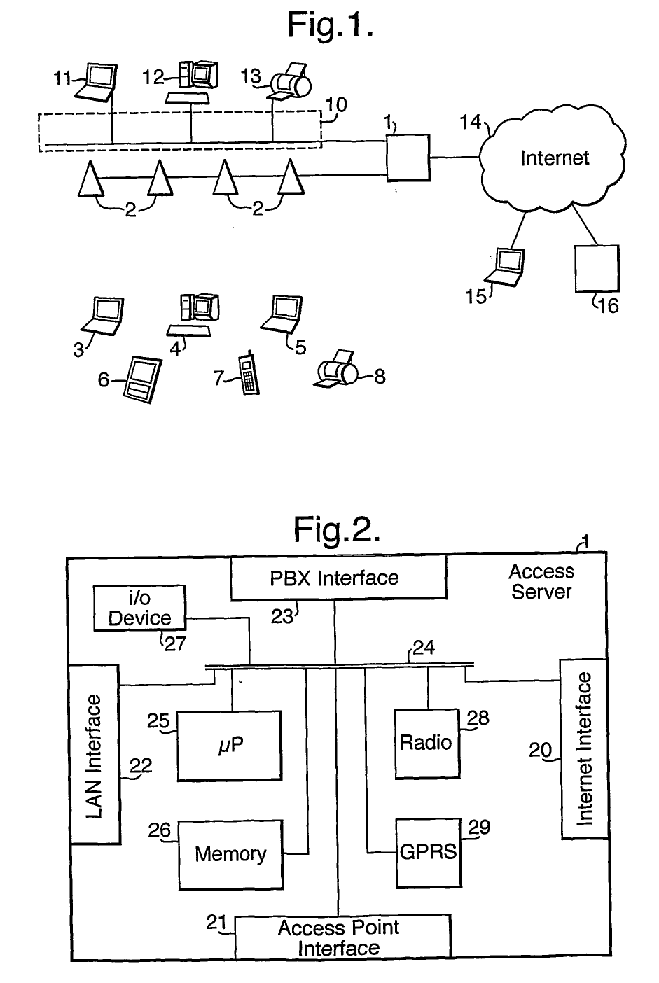

FIG. 1 shows a basic network arrangement according to the present invention. As shown, the network includes a wireless Internet server (WIS) or “Access Server” 1 which is coupled to a number of local area network access devices (LAN access devices (LADs)) or “Access Points” 2. The LADs 2 are designed to communicate with a number of wireless communications devices 3,4,5,6,7,8 using a wireless communications standard such as Bluetooth, DECT, or the like.

The wireless communication devices 3,4,5,6,7,8 can include devices such as a personal computer, laptop or the like which is fitted with a Bluetooth adapter, a specialised Bluetooth laptop, a Bluetooth enabled phone or mobile phone, a WAP Internet phone, a Bluetooth enabled printer, a Bluetooth enabled personal data assistant (PDA) or a Bluetooth headset. In this example, each of these devices will be able to communicate with the LADs thereby allowing the devices to obtain data from, or send data to the WIS.

In fact, the WIS and LAD can communicate with any Bluetooth enabled device. These include not only PCs, PDAS, and laptops but any of the following that have a Bluetooth port; a truck, a refrigerator, a baggage trolley, a keyboard etc.

The WIS 1 is also optionally connected to a local area network 10 having a number of end stations 11,12,13. In this example, this allows the WIS to be integrated with currently existing local area networks within a building.

The WIS 1 can also be connected to a remote communications network 14, which in this example is the Internet. This allows the communications devices coupled to the WIS to communicate with remote users 15 or WISs of other remote sites 16.

Accordingly, the LADs 2 allow the wireless communications devices 3,4,5,6,7,8 to communicate with the LAN 10 and the Internet 14 via the WIS 1. The WIS will typically operate as a network server and can therefore typically store information to be retrieved by the communications devices, including information downloaded from the Internet.

The WIS is shown in more detail in FIG. 2.

The WIS includes an Internet interface 20, a LAD interface 21, a LAN interface 22 and a PBX interface 23, all of which are interconnected via a bus 24. A microprocessor 25 and a memory 26 which are provided for processing and storing the operating software, are also coupled to the bus 24. An input/output device 27 is also provided.

The processor 25 is typically an x86 type processor operating a linux type operating system such as Red Hat linux. This is particularly advantageous as the linux system is widely used as the operating system for a number of different software applications. Accordingly, the system can implement a wide variety of standard operating software for network servers and the like, as well as allowing third parties the opportunity to modify existing software and develop their own software. However, any suitable form of processing system may be used.

In addition to these features, it is also possible to include a number of Bluetooth radios 28, and a GPRS transceiver 29, both of which are coupled to the BUS 24.

A range of radios are supported, including standard and enhanced range devices.

Similarly, the Bluetooth design of the WIS and the LAD offers capabilities beyond the basic Bluetooth specification. These include advanced control of

Bluetooth device state to improve throughput, and control of broadcast and multicast traffic streams to/from Bluetooth devices.

In this example, four different interfaces 20,21,22,23 are shown. However, it is not essential for the WIS I to include all of these interfaces, depending on the particular configuration which is to be used, as will be explained in more detail below.

Thus, in order to enable Bluetooth communication between the wireless communication devices and the WIS, only the LAD interface 21, with appropriately connected LADs 2, is required. In this case the Internet interface 20, the LAN interface 22 and the PBX interface 23 are not necessarily required. Alternatively, the LAD interface need not be used if the Bluetooth piconets are used instead.

However, this will become clearer when various network configurations used by the WIS are described in more detail below.

The Internet interface 20 is used primarily for providing an ISDN connection to an Internet service provider. However, the system can be reconfigured to use Ethernet, DSL or a POTS modem for Internet connectivity.

The LAD interface 21 is effectively an Ethernet interface which is adapted to operate with the LADs, as will be explained in more detail below.

The LAN interface 22 is normally configured to be an Ethernet interface. However, this can be adapted to provide token ring or other forms of communication as required. Accordingly the LAN 10 can comprise an Ethernet, Token Ring or other similar network.

In order to be able to handle different communications protocols, each of the interfaces 20,21,22 will include a processor and a memory. The processor operates software stored in the memory which is appropriate for handling the required communications protocol. Thus in the case of the LAN interface 21, the default protocol is Ethernet However, if alternative protocols such as Token Ring or ATM are used, then the software is adapted to translate the format of the data as it is transferred through the respective interface.

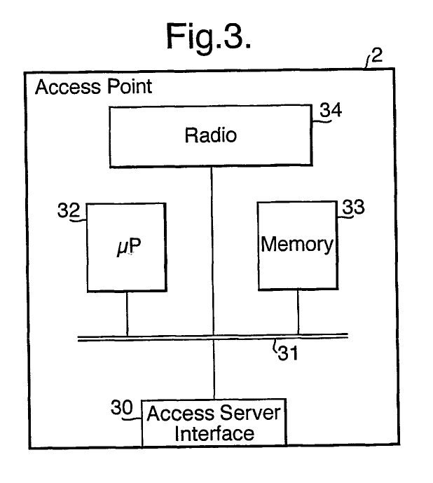

A LAD according to the present invention is shown in FIG. 3. The LAD includes a WIS interface 30, for connecting the LAD to the WIS. The WIS interface 30 is connected via a BUS 31 to a processor 32 and a memory 33. The BUS is also coupled to a number of Bluetooth radios 34 (only one shown) providing enhanced capabilities such as improved bandwidth and call density.

The processor 32 is typically a processor system that can include one or more processors, of the same or different types within the system. For example, the processor system could include, but is not be limited to, a RISC (Reduced Instruction Set Computer) processor and a DSP (Digital Signal Processor) processor.

In use, the LADs are connected to the LAD interface 21 using a daisy chain Ethernet connection. This is particularly advantageous as it allows a large number of LADs 2 to be connected in series via a single wire to the LAD interface 21. In this case, power can be supplied to the LADs 2 either via the connection from the WIS 1, or via separate power supplies (not shown) connected to each of the LADs 2 as required.

In use, each LAD 2 is able to communicate with a number of communications devices 3,4,5,6,7,8 which are in range of the respective radio 34.

Any data received at the radio is transferred to the memory 33 for temporary storage. The processor 32 will determine from the data the intended destination. If this is another Bluetooth device within range of the LAD, the data will be transferred via the radio 34 to the appropriate communications device 3,4,5,6,7,8.

Otherwise the data will be transferred via the BUS 31 to the WIS interface 30 and on to the WIS 1.

Upon receipt of the data by the WIS 1, the LAD interface 21 will temporarily store the data in the memory whilst the processor determines the intended destination of the data. The processor may also operate to translate the format of the data, if this is necessary. The data is then routed by the WIS to the intended destination on either the LAN 2, the Internet 14 or alternatively, to a PBX network, as will be described in more detail below.

The traffic from Bluetooth devices (arriving through a LAD or the WIS) can be sent to the LAN through a number of different mechanisms; one is routing, another uses a technique called Proxy ARP to reduce the configuration needed.

These mechanisms are bi-directional and also connect traffic from the LAN to Bluetooth devices.

Similarly, data can be transferred from the WIS, via the LAD interface 21 to a LAD 2. In this case, the LAD 2 receives the data and transfers it into the memory 33. The processor 32 then uses the data to determine the intended destination communication device before routing the data appropriately.

From the above it will be realised that a number of different network configurations can be implemented using the present invention. Examples of some of these will now be described.

The WIS 1 is a focal point for Bluetooth communication and provides a central point for managing and controlling Bluetooth mobile devices. The WIS 1, leveraging it's knowledge of Bluetooth connectivity, can be used to update these mobile devices, provide status on their whereabouts, provide backups etc.

The WIS 1 provides a WAP gateway to allow WAP enabled Bluetooth mobile devices to browse WAP content or to have WAP content pushed to them.

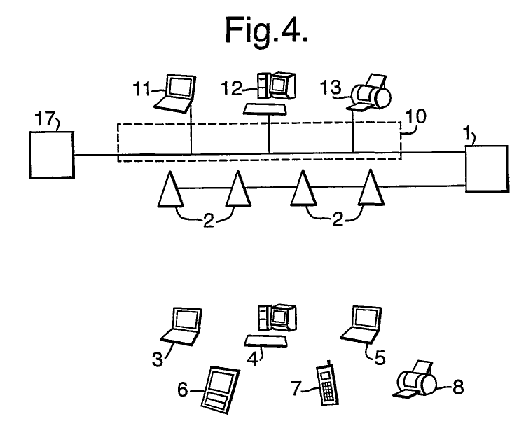

In the example of FIG. 4, the WIS is connected to a router 17 via the LAN 10. This allows the router 17 to be used to provide a managed link to the Internet, a corporate LAN, or the like. In this situation, the WIS I connects the communications devices 3,4,5,6,7,8 to the LAN 10 as well as allowing the Web caching feature to reduce the traffic on the Router 17.

In order to have local access controls over Internet use, the router 17 limits Internet access to the WIS 1 only. Accordingly, this forces users of the LAN 10 or the LADs to use the WIS as their gateway to the Internet.

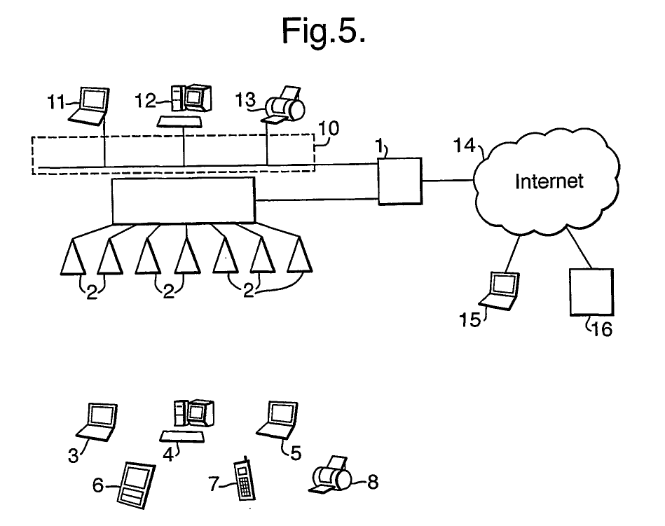

In some cases, for example in buildings which already have structured wiring, the daisy chaining of LADs may not be appropriate. Accordingly, the LAD port 21 is adapted to be connected to a vanilla Ethernet switch 19 to connect LADs 2 to the WIS as shown in FIG. 5. This offers power over Ethernet for the LADs obviating the need for each LAD to have a separate power supply.

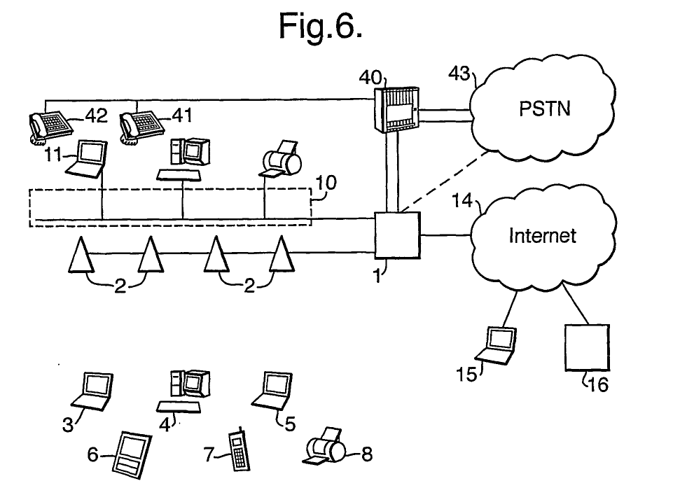

FIG. 6 shows an example in which a connection to a PBX 40 is implemented, the WIS 1 will have the ability to associate communications devices 3,4,5,6,7,8 such as Bluetooth phones and handsets as extensions of the PBX.

This allows Bluetooth enabled phones to call phones 41,42 on the PBX 40, as well as making calls to public telephone networks 43, such as the PSTN (Public Switched Telephone Network) or POTS (Plain Old Telephone System).

For example, this enables the Bluetooth phone or headset to ring at the same time, or instead of a users desk phone 41,42. Indeed, the invention enables the Bluetooth phone to have all the features offered by the PBX as a minimum functionality; on top of this, some new features can be added.

The use of Bluetooth 3in-1 phones which are capable of both Bluetooth and cellular communications allows users to use their cellular phone as their desk phone when in the office.

Where the PBX has no appropriate support for ISDN, the WIS PBX interface 23 can be connected directly to the public network 43 as shown by the dotted line, to provide direct dial-in and dial out to Bluetooth phones and headsets.

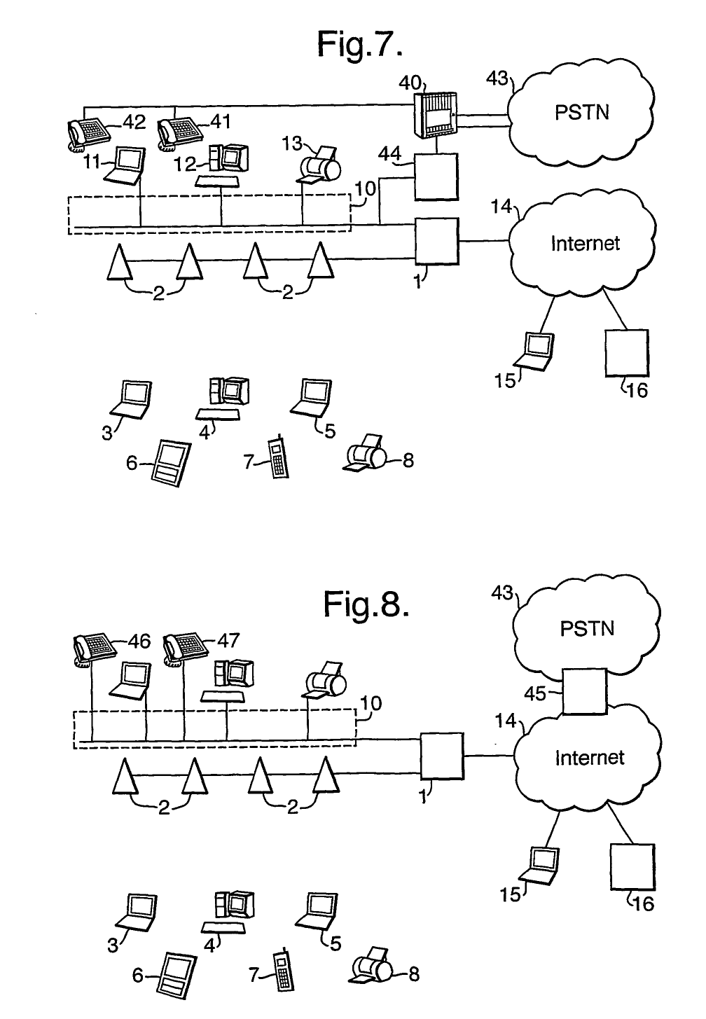

The LADs 2 can also provide VoIP (Voice Over IP) connectivity to the WIS, as shown in FIG. 7. In this example, the WIS 1 is connected to the PBX 40 through a VoIP gateway 44 connected to the LAN. The LADs implement voice compression algorithms hence providing a scalable VoIP solution (i.e. compression ability is increased with each LAD).

In the example of FIG. 8 VoIP, replaces the PBX 40 to allow connection to the telephone network 43. This is achieved by using a VoIP gateway 45 positioned between the Internet 14 and the phone network 43, to allow all phone calls to be transferred via the Internet 14 and the WIS 1. In this example Ethernet phones 46,47 can connect directly to the LAN 10, whilst the WIS 1 provides a gateway from Bluetooth phones and headsets to the Internet and hence on to the phone network 43.

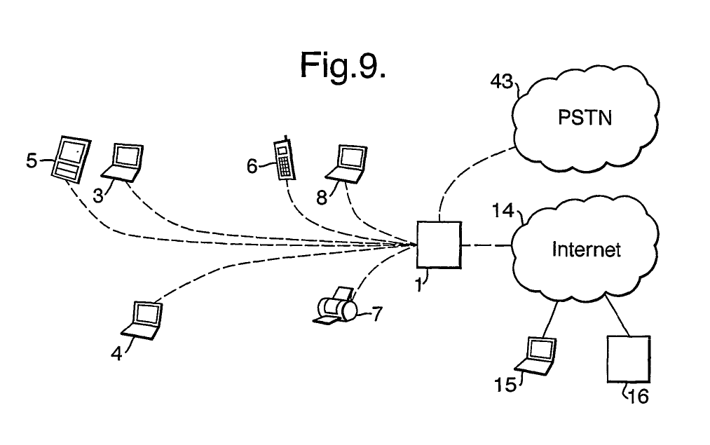

In the example of FIG. 9, the GPRS system is used to provide constant on-line connection to the Internet. This is achieved using the GPRS transceiver 29 to provide the GPRS connection to the Internet 14, and the phone network 43, and using the Bluetooth piconets 28 to provide the connection from the WIS 1 to the communications devices 3,4,5,6,7,8. In circumstances where GPRS services do not provide sufficient bandwidth for all applications, the system may use dial-up ISDN to increase bandwidth. The always on full time connection to the Internet 14 provided by GPRS enables features such as VPN and public Web serving to be used, especially where additional bandwidth can be dialled up on demand.

In a mobile environment, it will be normal to use GSM phones for voice support There may be added value in providing mobile voice connectivity via the WIS.

Thus, the WIS 1 provides wireless Internet and LAN access to a variety of Bluetooth enabled communications devices including PCs, printers, PDAs and WAP phones. It will also provide services specially tailored for PDAs through the use of OBEX (Object Exchange protocol) and WAP technology in the WIS 1.

It will be appreciated from this that many users may be connected to the WIS via the LADs at any one time. Accordingly, it is necessary for the entire network system to operate a registration procedure to ensure that only authorised users of the system can have access.

Accordingly, the WIS 1 stores a list of authorised users in the memory 26.

In each case, a user name and password is provided for the user so that when they first access the system, the user name and password must be entered.

The WIS and LAD can implement a number of different security solutions. These range form low level authentication procedures inherent in Bluetooth devices, to high level security features which are simple, easy to use and deploy services which operate in conjunction with or instead of Bluetooth specific security features. This allows a deployment of the WIS and LADs in a range of sites and applications.

Once this has been completed, the WIS will associate a device indication with the associated user name and password. This ensures that a record is maintained of which device is being used by the user. Accordingly, any subsequent data addressed to the user can be sent directly to the device.

Thus, if the user is using a wireless communications device 3,4,5,6,7,8, the WIS will store an indication of the device, either as a particular address, device identifier, or the like together with the user name and password. If any E-mail or the like is then received for that particular user, this can be directed to the device automatically.

The WIS can store data concerning which radio 34,28 the user's communication device 3,4,5,6,7,8 is attached to. Every time a user's communication device 3,4,5,6,7,8 moves from one radio 28,34 to another there is a disconnection and reconnection process. To make this as seamless as possible a “roaming” capability is operated by the processor to allow the controlled hand-off from one radio to another.

The use of user names and passwords provides a convenient way of limiting the access available for each user will be described in more detail below.

As will be appreciated from the above, the WIS is adapted to deliver a full range of services expected of any Internet access solution. These include advanced Internet Firewall protection, VPNs (Virtual Private Networks) for secure communications across the Internet, Web page caching to reduce the time taken to download frequency accessed web pages, and an E-mail server for immediate access to Internet E-mail within the office. In more detail, the capabilities of the WIS include:

Internet Connection

The WIS 1 is adapted to establish connections to the Internet 14 using a number of protocols. This allows the use of full time connections to the Internet such as DSL and GPRS, or the use of a simple dial-up connection through a telephone modem or ISDN link. The WIS can schedule delivery of E-mail to avoid excessive call charges where Internet access is through a dial-in connection, or where large E-mails might flood the connection to the Internet.

The WIS implements complex logging and access control. This permits the user to log all activity on the Internet ports, and configure multiple parameters for controlling access (e.g. dial up limited to 5 minutes per hour, dial up not permitted after 8 pm etc.)

The WIS can also provide a local caching capability in the memory 26 to improve the speed of Web browsing to commonly accessed Web pages. In this way Web pages that are accessed by multiple users, as is typically the case for LAN content, have access speeds that are substantially improved.

E-mail

The WIS 1 operates as an E-mail server that will deliver and access external E-mail via the Internet connection and also manage internal E-mail traffic.

The WIS provides a comprehensive E-mail service for all users, improving communications within the office and providing efficient E-mail delivery to and from suppliers, partners and customers in the Internet 14. Facilities enable local or remote administration so that functionality such as creating a mail group can be achieved by a non-technical administrator.

Web Server

The WIS 1 provides a Web server to enable the generation of Web page content. Where there is an appropriate full time connection from the WIS 1 to the Internet 14, external web pages can be served to the Internet, or alternatively can be delivered automatically to an external server in the Internet. Indeed, the WIS can store & serve both Web and WAP content

Firewall

The firewall protects the internal data resources from access via the public Internet and is integral to providing a VPN capability for communication for mobile users out of the office. In addition, the WIS provides user control access that enables an administrator to control what users in the office can access from the Internet Blacklists ensure that users cannot access inappropriate Web sites, while white-lists can limit certain users to only those Web sites that are needed for their work.

The firewall is implemented separately for each of the interfaces, 20,21,22.

Thus, any data transferred via a respective one of these interfaces must pass through a respective firewall. This allows different settings to be applied to the firewalls to allow different data to be restricted as required.

Thus for example, access to the LAN from the LAD connection could be restricted to only allow the transfer of certain types of data. This would allow guest users to log onto the LAD system, using their own Bluetooth enabled communications device without allowing the user access to confidential information stored on the LAN. In addition to this, the user could log on with a “guest” password which would limit the user to say for example Internet access via the WIS 1.

In order to achieve the firewall system, for each interface 20,21,22, the memory of each interface must store a list of user name passwords, together with details of the level of access permitted to each user. The memories will also contain blacklists of restricted data types or destination or source addresses. This can therefore be used to limit the information which can be downloaded from the Internet.

File Server

The WIS supports file storage for network clients that use, for example, the Microsoft™ SMB protocols. The WIS can act as an FTP (File Transfer Protocol) proxy to allow LAN clients to write files to and from servers on the Internet

Address Translation

NAT (Network Address Translation) allows multiple Internet users on the LAN to use a single Internet IP address. NAT is used to disguise the internal networks addressing scheme from the Internet and share a single Internet IP address with all the users of the WIS.

VPN

Traditionally remote users access office data by remotely dialling in to the office server. In creating a secure VPN the travelling user or home office user can access all the data resources, that they have rights to, in the office, through a remote Internet connection. The VPN enables a user to access data anywhere via Internet access to a local POP (Point of Presence) at the price of a local call.

In the same way remote branches can access the data resources of the head office through a remote Internet connection eliminating the costs associated with having a permanent leased line between sites. To support a VPN link requires a permanent Internet link to the WIS.

The WIS 1 also provides interconnection to a variety of network environments. These include:

Base WAN & LAN Connectivity

This WIS provides Ethernet connectivity support connectivity of the WIS to an existing LAN. Where an existing LAN is used for internal connection of desktop PC's and printers then the WIS can also provide access to the Internet for these devices.

The WIS can also support a Token Ring Interface as an additional LAN configuration.

A variety of WAN interfaces are provided to cater for differing requirements in a data bandwidth and regional variations in the preferred connectivity. ISDN is widely used for WAN connectivity and provided with the ISDN being supported by dial on demand features to optimise call charges.

The WIS also allows other WAN technologies such as DSL to be implemented.

GPRS

GPRS connectivity can be used to provide a wireless out of building connection to a mobile network. GPRS provides an “always on” connection. In this way any remote access or site to site access can instantly communicate across the VPN network rather than relying on dial up intervals.

In some applications the combination of an always on GPRS link with a dial up ISDN line as a dynamic link aggregation for higher bandwidth offers a good balance of functionality and optimising call charges. This can be implemented using intelligent call management techniques to be employed.

Voice Communication

The WIS is also adapted to handle voice communication. This can be activated either by using voice over IP and transferring the call via the Intemet, or by using the PBX interface. The PBX adapter allows connection to an existing PBX so that when an incoming call can be transferred to an extension which rings the Bluetooth phone via the Bluetooth connection. The Bluetooth phone becomes a portable extension of the desk phone. If the Bluetooth phone is incorporated in a mobile phone, these phones are referred to as 3-in-1 phone, the three modes being: GSM calls outside of the office environment, cordless calls and intercom calls directly between Bluetooth phones when inside the office.

Headsets can also be utilized as an extension to a personal mobile phone, or to be used to receive calls directly from a base station.

Accordingly, the WIS provides the gateway for external voice traffic whether via a PBX interface or VoIP traffic directly over an IP connection. The use of VoIP allows several different communication protocols to be implemented, such as Megaco (also referred to as H.248). Using this approach the LAD effectively becomes a VoIP interface to a LAN.

It will be realised from the above that the system can be adapted to provide a wide range of additional services. Some of these will now be described below:

The LAD system can be integrated into currently existing IP phones by adding in an appropriate Bluetooth piconet. Accordingly, the IP phones provided in the office effectively act as the LADs 2. In this case, separate LADs 2 connected to the LAD interface 21 are not required. As a result, the desk top phones in the offices will provide a high quality of service connection to the LAN for remote users, via the additional wireless link. This allows communications devices 3,4,5,6,7,8 access to the WIS 1 without the requirement of separate LADs 2 being wired in to the system. In this case, the Bluetooth piconets within each phone can be controlled by the WIS so as to support roaming as the system user walks in and out of the range of different desktop phones. As will be appreciated by a person skilled in the art, this can advantageously be used to allow a mobile phone to be used instead of the desktop phone to allow roaming around an office.

The LADs can also be utilised to synchronise the operation of two communications devices 3,4,5,6,7,8 so that the features on one communication device can supplement those available on another. Thus, for example, Bluetooth enabled headsets typically only include controls for answering calls and controlling the call volume. The headsets are therefore typically implemented in conjunction with any desk phone. In this case, the system user can redirect their standard desk phone to reroute calls to the Bluetooth headset This will allow the user to receive calls via the headset instead of the phone. However, in this case, the user can only make outgoing calls by dialling the call from the desk top phone.

To overcome this, the WIS is adapted to supplement the services provided to the headset by providing additional controller information to an alternative communications device, such as a PDA. This is typically achieved using WAP pages or the like stored in the WIS 1. Thus, in this example, the user will have a PDA and a Bluetooth enabled headset registered with the system such that the WIS 1 is able to determine that both the PDA and Bluetooth headsets are in use by the same user. The system user can then access a WAP page stored in the WIS 1 which sets out various call control features. The system user can use the PDA to select call features such as call dial up, so as to make an outgoing call. The WIS will then use the normal voice communication protocol to dial up the call. Thus, for example, if the WIS 1 is connected to a PBX 40, the WIS 1 will generate instructions causing the PBX 40 to make an outgoing call to the desired number.

Alternatively, the call may be made as VoIP or the like. In this example, when the call is answered the WIS 1 then generates a call signal which is transferred to the Bluetooth enabled headset. This causes the Bluetooth enabled headset to ring allowing the user to answer the headset and thereby complete the call, as required.

It will be realised from this, that as the WIS controls the call handling, by setting up the call, the WAP page presented to the user on the PDA can be altered as the call proceeds. Thus, when the user is initiating the call, the WAP page may represent a standard numeric keypad allowing the user to dial the call. However, once the call has been initiated, the WAP page displayed to the user can change to provide indications of additional supplementary services, such as call transfer, call forward, call hold or the like. In this case, the user can select an appropriate feature and the WIS will control the operation of the PBX, via the PBX interface 23 accordingly. Alternatively, similar controls can be implemented for the VoIP calls.

The idea of using an auxiliary control path, such as a PDA link to a WAP page, can be extended to also allow additional services to be provided for standard telephone calls, for example over the public phone network 44. In this case, when a standard telephone call is in progress, a WAP page indicating supplementary services could be displayed to the user. This would include features such as call transfer which are not currently available on the phone network 44. In this case, if the user selects call transfer, this will cause the WIS to initiate a second telephone call to the desired transfer destination. Once the second telephone call has been initiated between the WIS 1 and the phone network 44, the WIS 1 can operate to transfer the calls as instructed by the PDA.

It will be appreciated from this that the PDA could be used to implement a vast variety of functions. Thus, for example, the WIS 1 could be interconnected to control functions for building itself. This would typically be achieved by having computer implemented control of building functions, such as temperature, lighting or the like. The PDA could then access the computer via the WIS allowing users to control lighting, temperature or the like using a PDA or other Bluetooth enable device.

As an improvement over this system, the WIS can be adapted to determine the location of users by monitoring which LAD the users Bluetooth enabled devices are currently connected to. Thus, the WIS can track the motion of a user around a building using the roaming monitoring of the LADs. This allows writing, and other building features to be controlled in accordance with the user's location. Thus for example, the WIS can be adapted to automatically turn on lighting within a room as the user enters the room and their Bluetooth enabled device registers with the LAD in that room.

With the WIS being provided with multiple connection options, this allows for a variety of connection systems to be implemented in parallel to thereby provide optimum services to the user. Thus, for example, in a big business connection to the Internet may require high bandwidth access at times of high usage, whereas, at other times no access may be required. Despite this, it is useful to keep a full-time connection to the Internet so as to ensure that E-mails and the like are received as quickly as possible. In this situation, the GPRS transceiver 29 in the WIS 1 can be used to maintain a constant connection to the Internet. The bandwidth of this connection is monitored and when it exceeds a predetermined threshold, an ISDN connection is then initiated to provide higher bandwidth connections as required.

In addition to this, the GPRS can be used to carry VoIP traffic rather than native voice calls. This is particularly advantageous, as it allows a single GPRS connection to be used for connecting the WIS to the Internet so as to allow both data and voice communications.

The WIS 1 can also be adapted to automatically synchronise various functions of the Bluetooth enabled devices. Thus, the system can automatically detect a system user's PDA as it enters the building. This can be achieved by storing a registration code representative of the PDA. As the PDA enters the range of one of the Bluetooth radios, this allows th PDA to be synchronised with any other communication or end stations which are also registered to that specific user.

Thus, the WIS 1 maintains a list for each user name and password of all the devices associated with that user name. The system could then automatically update diaries, calendars, E-mails, Voice Mails and the like so they are present in all the communications devices within range of the Bluetooth radio. This would allow voice mails received at the desk top phones to be automatically sent to the user's mobile phone, or alternatively E-mails received at a desk top PC to be automatically sent to the user's PDA.

The three-in-one mobile phone, which incorporate a Bluetooth connection can also be adapted so that the Bluetooth connection overrides any alternative connections if available. Thus, when the user dials a telephone number to make an external call, if the system is within the range of a Bluetooth radio, the call will automatically be transferred via the Bluetooth radio and the WIS 1 to the phone network 44. This can be achieved, using either the VoIP or a PBX network.

Alternatively, if the user is out of range of a Bluetooth radio, then the call will be established using standard GSM technology.

The WIS 1 also implements an e-mail to SMS gateway allowing any e-mail enabled device connected to the WIS to communicate with SMS enabled devices.

For example, a Bluetooth enabled laptop can send an e-mail to the WIS, whereupon the WIS will then convert this message to an SMS message and forward to the designated SMS endpoint. Similarly, the SMS endpoint can be used to send SMS messages directly to any mail endpoint attached to the WIS using the e-mail to SMS gateway. Advanced management features are provided; two examples are

allowing the e-mail user to send the SMS message to the e-mail address of the destination, rather than a phone number;

allowing the receiver of a message to reply directly without needing to know the email address or SMS number of the sender.

The WIS can also be used to allow the control of network devices. This includes devices such as printers, fax machines, photocopiers and the like.

1. A wireless communications network comprising:
a plurality of network nodes which can communicate wirelessly with a plurality of end stations coupled to the network; and
a network server,
wherein the network nodes are connected to the network server and the network server is connectable to other communications networks,
the network nodes and network server including:
identification means to store and access details relating to the end stations;
memory means to store data which is to be communicated to a user in one of a plurality of different protocols; and
transfer means to dynamically translate and connect different data streams and protocols, in use the particular protocol used for a data stream being dependent on the stored details relating to the end stations.

2. A wireless communications network according to claim 1, wherein the wireless connections include one or more of Bluetooth radio connections, wireless LAN connections, DECT connections, Wireless local loop connections and GPRS connections.

3. A wireless communications network according to claim 1 or 2, wherein the network server is connectable to hardwired communications networks.
